(19) United States
(12) Patent Application Publication
(10) Pub. No.: US 2011/0228264 A1
(43) Pub. Date: Sep. 22, 2011

(54) SERS Nanotags With Improved Buoyancy in Liquids

(75) Inventor: Felicia Tam, Sunnyvale, CA (US)

(73) Assignee: CABOT SECURITY MATERIALS INC., Mountain View, CA (US)

(21) Appl. No.: 13/053,601

(22) Filed: Mar. 22, 2011

Related U.S. Application Data
(60) Provisional application No. 61/316,273, filed on Mar. 22, 2010.

(51) Int. Cl. G01J 3/44; B05D 7/14; B82Y 15/00; B82Y 20/00

(52) U.S. Cl. 356/301; 427/216; 977/904; 977/773

(57) ABSTRACT

A suspendable SERS nanotag. As used herein, a suspendable tag is one which remains suspended in a specific liquid, water for example, for a period of time. Thus, a suspendable tag does not sink to the bottom of a container of the liquid or float to the top of a container of the liquid within the selected time period. A suspendable SERS nanotag may include a metal core, for example, an Au core having a diameter of less than 90 nm. The suspendable SERS nanotag may also include a SERS active reporter molecule associated with the core and a silica containing encapsulant, encapsulating the core and reporter association.

This application claims the benefit under 35 USC section 119 of U.S. provisional application 61/316,273 filed on Mar. 22, 2010 and entitled “SERS Nanotags With Improved Buoyancy in Liquids,” the content of which is hereby incorporated by reference in its entirety and for all purposes.

### BACKGROUND

SERS nanotags have proven to be useful markers in a variety of tracking applications. Certain known SERS nanotags include 90 nm Au cores, in some cases aggregated to form dimers, trimers, etc., with the core materials coated by silica. Due to their size and mass these particles will settle to the bottom of a container of many liquids over a period of days to weeks. For example, over a 12 h period, a 0.05 g/mL suspension of selected SERS nanotags will have settled far enough to leave the top layer of the suspension clear, and some of the larger particles in the suspension will have visibly settled to the bottom of the container. For selected implementations, the inability of known SERS nanotags to remain suspended for extended periods of time when mixed into a liquid is problematic.

The embodiments disclosed herein are directed toward overcoming one or more of the problems discussed above.

### SUMMARY OF THE EMBODIMENTS

One embodiment is a suspendable SERS nanotag. As used herein, a suspendable tag is one which remains suspended in a specific liquid, water for example, for a period of time. Thus, a suspendable tag does not sink to the bottom of a container of the liquid or float to the top of a container of the liquid within the selected time period.

A suspendable SERS nanotag may include a metal core, for example, an Au core having a diameter of less than 90 nm. The suspendable SERS nanotag may also include a SERS active reporter molecule associated with the core and a silica containing encapsulant, encapsulating the core and reporter association.

The metal core of the suspendable SERS nanotag may have a diameter of about 40 nm, 25 nm or 15 nm. The core may be an aggregation of metal particles.

An alternative embodiment is a method of fabricating a suspendable SERS nanotag. The method includes providing a metal core having a diameter of less than 90 nm. The method further includes associating a SERS active reporter molecule with the metal core and encapsulating the core and reporter association with an encapsulant. The method may further include providing a core having a diameter of about 40 nm, 25 nm or 15 nm. The method may alternatively include providing an aggregated core.

### BRIEF DESCRIPTION OF THE DRAWINGS

FIG. 1 is TEM micrographs of multiple SERS nanotags as disclosed.

FIG. 2 is a plot of the UV-vis absorbance of the tags of FIG. 1.

FIG. 3 is multiple plots of the SERS spectra of the tags of FIG. 1.

FIG. 4 is TEM micrographs of multiple SERS nanotags as disclosed.

FIG. 5 is a plot of the UV-vis absorbance of the tags of FIG. 4.

FIG. 6 is multiple plots of the SERS spectra of the tags of FIG. 4.

FIG. 7 is TEM micrographs of multiple SERS nanotags as disclosed.

FIG. 8 is a plot of the UV-vis absorbance of the tags of FIG. 7.

FIG. 9 is multiple plots of the SERS spectra of the tags of FIG. 7.

FIG. 10 is TEM micrographs of multiple SERS nanotags as disclosed.

FIG. 11 is multiple plots of the UV-vis extinction and SERS spectra of the particles of FIG. 10.

FIG. 12 is TEM micrographs of multiple SERS nanotags as disclosed.

FIG. 13 is multiple plots of the UV-vis extinction and SERS spectra of the particles of FIG. 12.

### DETAILED DESCRIPTION

One non-exclusive and non-limiting type of tag which is described herein and which may be modified according to the disclosed methods and with the disclosed materials is a SERS nanotag, also referred to as a SERS tag. SERS nanotags are nanoparticulate optical detection tags which function through surface enhanced Raman scattering (SERS). SERS is a laser-based optical spectroscopy that, for molecules, generates a fingerprint-like vibrational spectrum with features that are much narrower than typical fluorescence.

A typical SERS nanotag includes a metal nanoparticle core and a SiO₂ (glass) or other silicon containing encapsulant. Other materials including but not limited to various types of polymers may also be used as an encapsulant or shell. Details concerning the use, manufacture and characteristics of a typical SERS nanotag are included in U.S. Pat. No. 6,514,767, entitled “Surface Enhanced Spectroscopy-Active Composite Nanoparticles,” which patent is incorporated herein by reference for all matters disclosed therein. Although the embodiments disclosed herein are described in terms of SERS nanotags prepared from single nanoparticle cores, it is to be understood that nanoparticle core clusters or aggregates may be used in the preparation of SERS nanotags. Methods for the preparation of clusters of aggregates of metal colloids are known to those skilled in the art. The use of sandwich-type particles as described in U.S. Pat. No. 6,861,263 is also contemplated, which patent is incorporated herein by reference for all matters disclosed therein.

The nanoparticle core may be of any material known to be Raman-enhancing. The nanoparticle cores may be isotropic or anisotropic. Nanoparticles suitable to be the core of a SERS nanotag include colloidal metal, hollow or filled nanobars, magnetic, paramagnetic, conductive or insulating nanoparticles, synthetic particles, hydrogels (colloids or bars), and the like. The nanoparticles can exist as single nanoparticles, or as clusters or aggregates of the nanoparticles.

Nanoparticles can exist in a variety of shapes, including but not limited to spheroids, rods, disks, pyramids, cubes, cylinders, nanohelixes, nanosprings, nanorings, rod-shaped nanoparticles, arrow-shaped nanoparticles, teardrop-shaped nanoparticles, tetrapod-shaped nanoparticles, prism-shaped nanoparticles, and a plurality of other geometric and non-geometric shapes. Another class of nanoparticles that has been described includes those with internal surface area. These include hollow particles and porous or semi-porous particles. While it is recognized that particle shape and aspect ratio can affect the physical, optical, and electronic characteristics of nanoparticles, the specific shape, aspect ratio, or presence/absence of internal surface area does not bear on the qualification of a particle as a nanoparticle. A nanoparticle as defined herein also includes a nanoparticle in which the metal portion includes an additional component, such as in a core-shell particle.

Each SERS nanotag is typically encoded with a unique reporter, comprising an organic or inorganic molecule at the interface between the nanoparticle core and shell of glass or other suitable encapsulant. This approach to detection tags leverages the strengths of Raman scattering as a high-resolution molecular spectroscopy tool and the enhancements associated with SERS, while bypassing the shortcomings often encountered when making stand-alone SERS substrates such as difficult reproducibility and lack of selectivity. SERS nanotags exhibit intense spectra (enhancement factors in excess of 10⁶) at 633 nm, 785 nm or other suitable excitation wavelengths, which wavelengths can be selected to avoid intrinsic background fluorescence in biological samples such as whole blood and in matrices like glass and plastic.

The encapsulant, which is essentially SERS-inactive, stabilizes the particles against aggregation, prevents the reporter from diffusing away, prevents competitive adsorption of unwanted species, and provides an exceptionally well-established surface. Glass or other silicates are well suited as encapsulants.

At the core of one standard type of SERS tag is a 90 nm diameter Au colloid. Although Au colloid of this particular size has been shown to yield favorable optical properties in the SERS tags, this (relatively) large, dense particle limits the suspendability of the SERS nanotag. As used herein, the term “suspendability” describes the ability of a tag to remain suspended in a liquid without supplemental agitation. A collection of fully suspendable tags will neither rise to the surface of a selected liquid nor sink to the bottom of the liquid over a selected period of time. Various liquids of interest have different specific gravities. Accordingly, a tag which is fully suspendable in a first liquid may not be suspendable in a second liquid. Many of the examples described herein relate to the suspension of tags in aqueous liquids or water. The techniques described herein are applicable to other liquids as well.

One method which may be implemented to increase the suspendability of SERS tags in an aqueous solution focuses on using smaller Au colloid cores. The colloids that were used in these experiments ranged in size from 15-40 nm in diameter. Characterization data of the most successful samples are detailed below. All of the samples demonstrate improved suspendability when compared to tags made with 90 nm Au colloid, but the SERS intensity produced is also lower. Concentrations reported throughout the examples below assume that no particles are lost through the multiple centrifugation steps used to clean the particles.

### EXAMPLES

The following examples are provided for illustrative purposes only and are not intended to limit the scope of the invention.

### Example 1

### SERS Tags from 25 nm Au Colloid

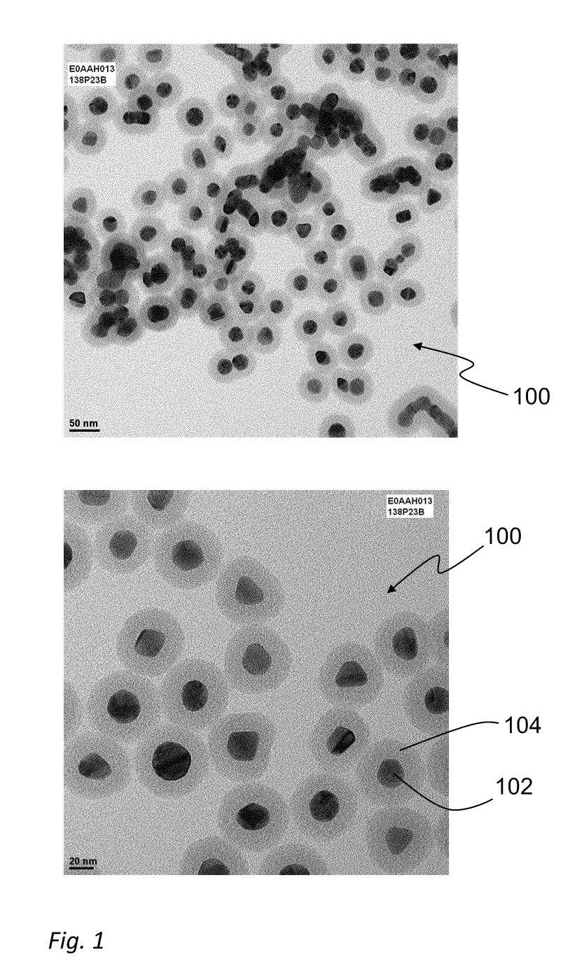

The particles manufactured and characterized in Example 1 consist of silica coated SERS tags 100 made with 25 nm Au cores 102. Representative particles are shown in the TEM micrographs of FIG. 1. The typical core diameters of the particles were measured from the TEM images for about 200 individual nanoparticles. BPE was selected as a reporter. The particles in the sample consist of individual particles and small aggregates which are coated with conformal silica shells 104 with a thickness of ˜20 nm.

The suspendability of the Example 1 particles was examined in water. Over a 24 hour period, no settling was evident to the naked eye. After several days, a small subpopulation of the particles appears to have settled to the bottom of the container, but there is no clear layer evident at the top of the suspension.

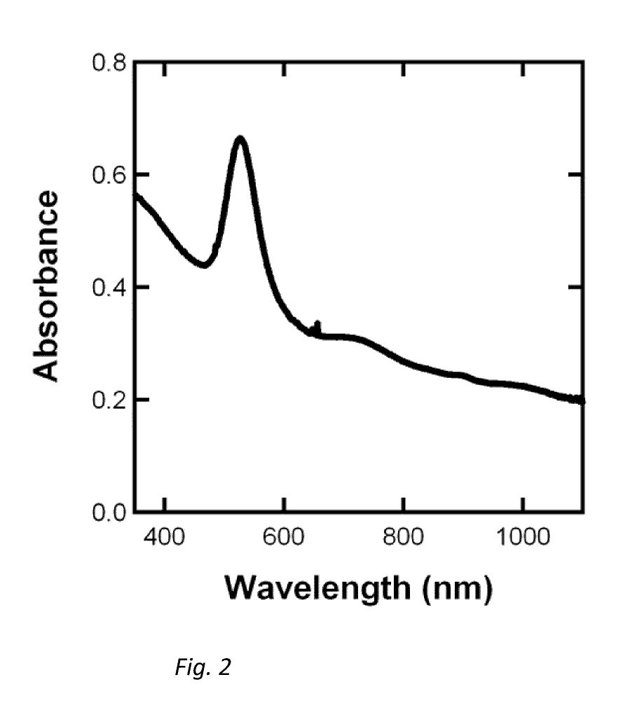

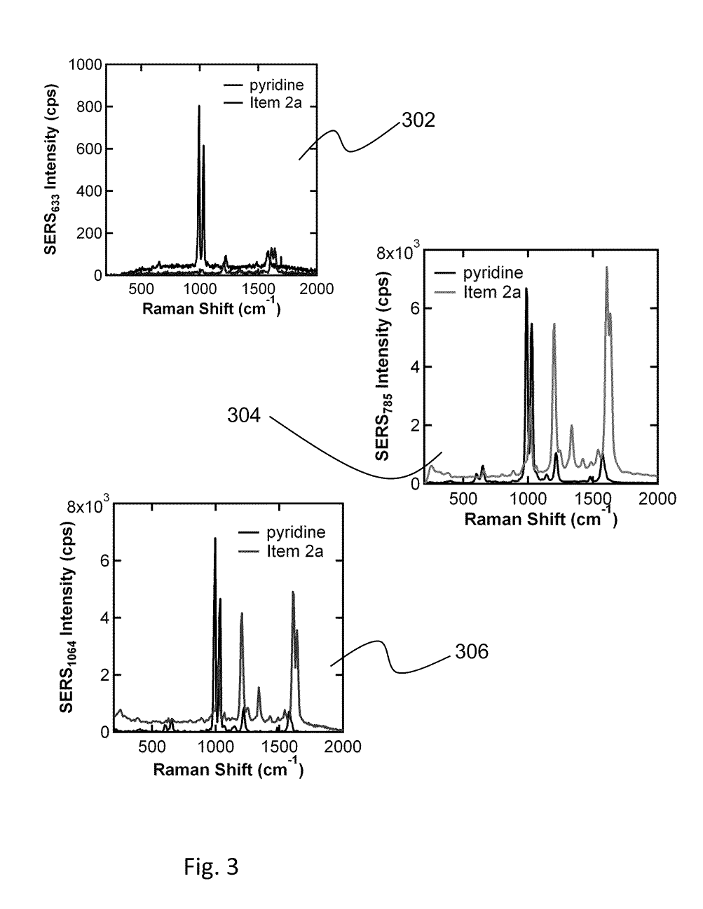

The light absorbance characteristics of the Example 1 particles over portions of the UV and visible spectrum are shown in FIG. 2. As shown in FIG. 3. There is good SERS response when the Example 1 tags are interrogated using excitation wavelengths of both 785 nm (graph 302) and 1064 nm (graph 304) excitation with a weak signal evident using 633 nm (graph 306). Each of the FIG. 3 spectra were obtained at a nominal Au concentration of 0.05 mg/ml.

### Example 2

### SERS Tags from 15 nm Diameter Au Colloid

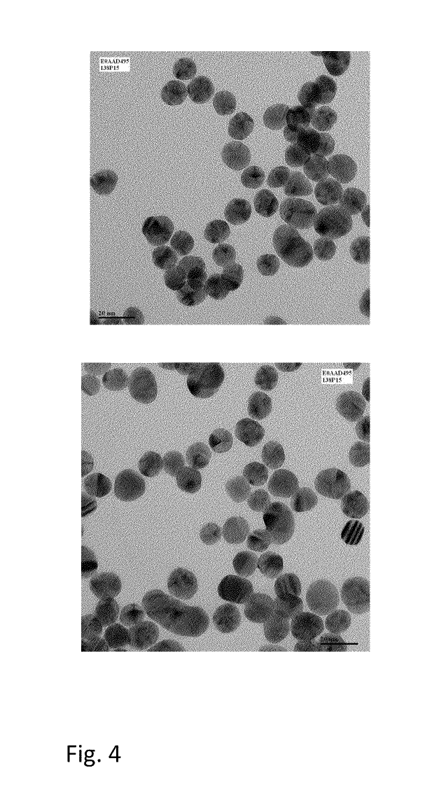

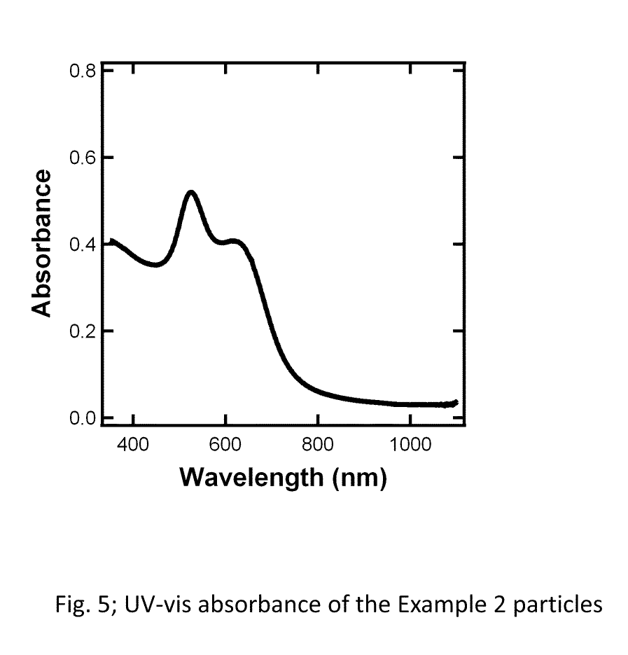

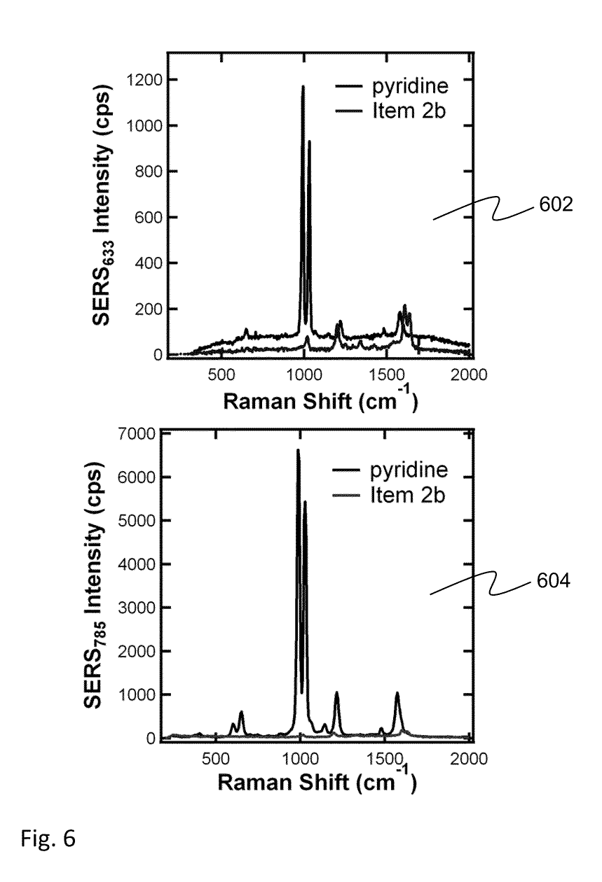

The particles manufactured and characterized in Example 2 consist of SERS tags made with 15 nm diameter Au colloid. As shown in FIG. 4, the particles of Example 2 consist of individual particles and small aggregates. The light absorbance characteristics of the Example 2 particles over portions of the UV and visible spectrum are shown in FIG. 5. As shown in FIG. 6, the particles of Example 2 exhibited relatively low SERS signals at 633 nm (graph 602) and 785 nm (graph 604). Each of the spectra was taken at a nominal Au concentration of 0.05 mg/ml. SERS was not observed from the sample when excited with a 1064 nm laser. The Example 2 particles exhibited excellent suspendability in water.

Although the Example 2 particles underwent a standard silica coating step, no silica shell was evident on the particles, as shown in the TEM micrographs of FIG. 4. Some high-resolution TEM images suggested that there may be a small amount of silica that was deposited on a few of the particles only. However, the lack of silica shell (which adds more mass to the particle) appears to have enhanced the suspendability of these particles. A subpopulation of this sample settled out after about a week, but the majority of the sample has not exhibited settling in water over the course of about a month. The suspended portion of the sample retains the SERS activity of the entire sample.

A portion of the particles of Example 2 was retooled to deposit silica on the surface. The resulting particles were coated with silica shells of ˜30 nm thickness. These retooled particles had similar SERS properties to the original sample, but settled out much more quickly. It may be possible to find an optimal silica thickness which is sufficient to protect the SERS activity of the tags, but which is thin enough to retain the suspendability of these tags.

### Example 3

### SERS Tags from “Au Web” Particles

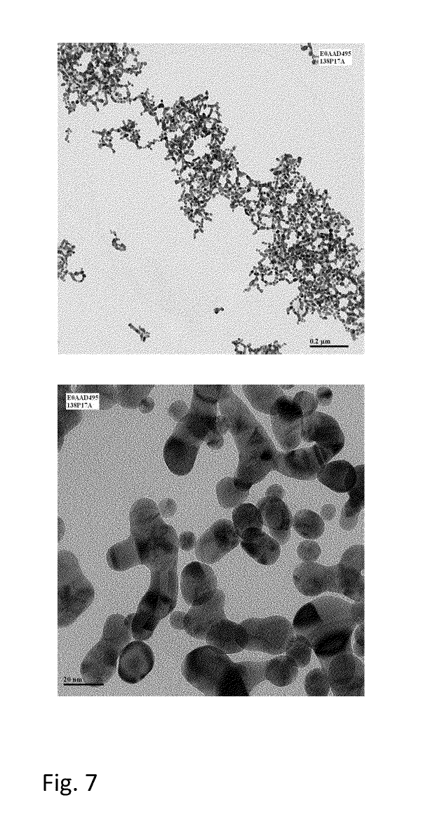

The particles of Example 3 consist of silica coated SERS tags made with Au colloid with an initial diameter of 14 nm (as measured by DLS (dynamic light scattering). As shown on FIG. 7, the particles of Example 3 fused during the fabrication process, so that the final sample consists of larger, aspherical gold particles. As was observed with the particles of Example 2, the initial silica growth step did not deposit a significant amount of silica on these particles.

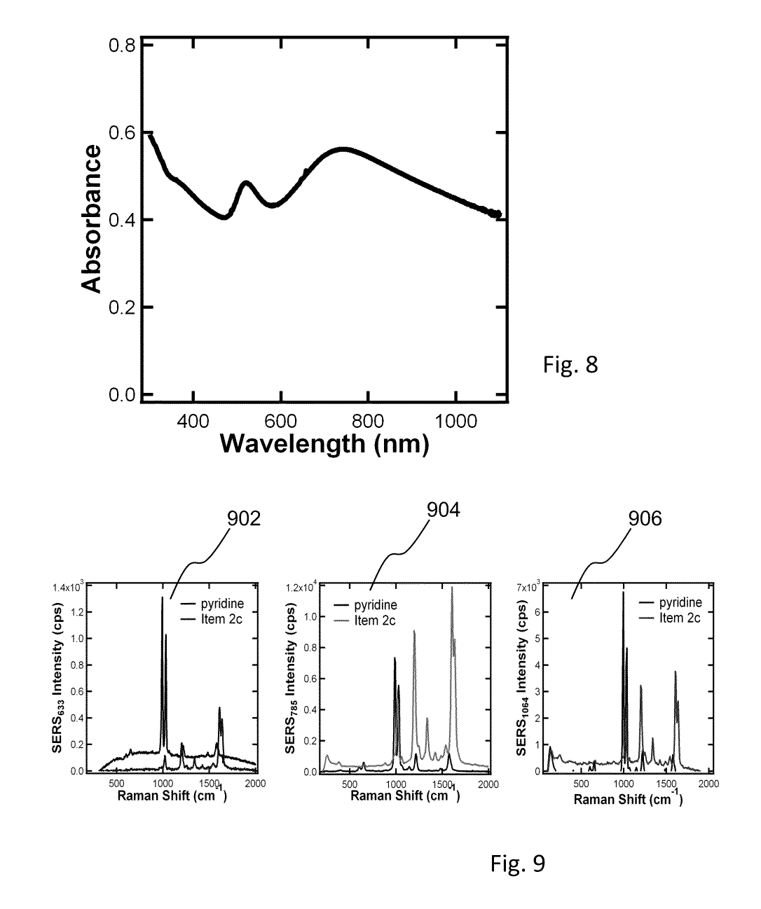

No settling was evident to the naked eye after a 24 hour period following suspension of the Example 3 particles in water. After several days, a small subpopulation of the Example 3 particles appear to have settled to the bottom of the container, but there is no clear layer evident at the top of the suspension. The particles were observed to begin to settle out of the top layer of the suspension over the course of several weeks. The light absorbance characteristics of the Example 3 particles over portions of the UV and visible spectrum are shown in FIG. 8. As shown in FIG. 9, The SERS signal from the Example 3 tags is reasonably strong at all wavelengths that were investigated. There is good SERS response when the Example 3 tags are interrogated using excitation wavelengths of 633 nm (graph 902). 785 nm (graph 904) and 1064 nm (graph 906). Each of the FIG. 3 spectra was obtained at a nominal Au concentration of 0.05 mg/ml.

### Example 4

### SERS Tags from 40 nm Au—Heavily Aggregated

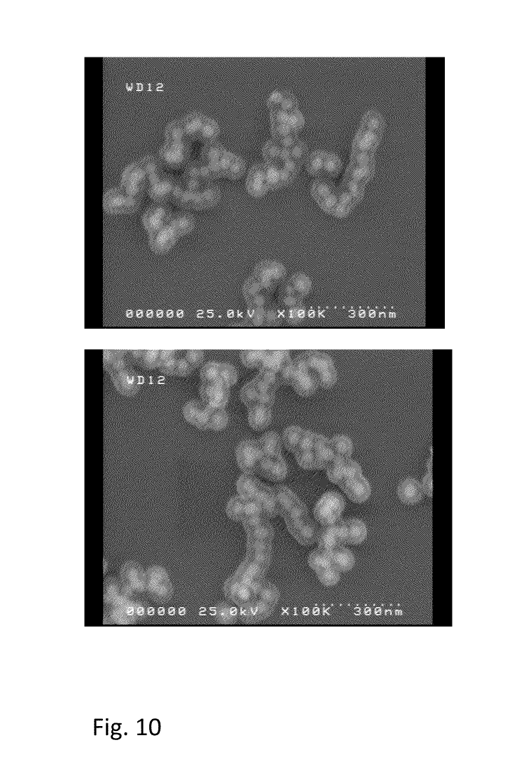

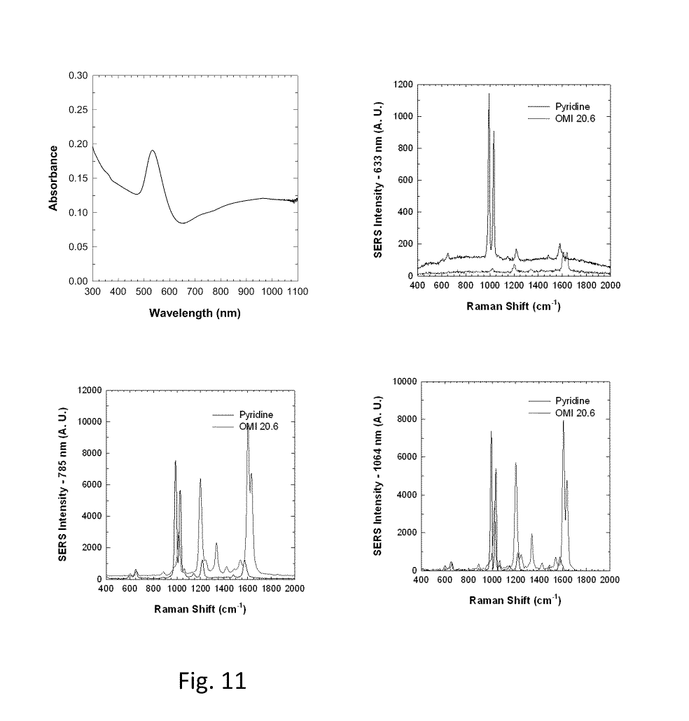

SERS Tags were prepared using standard methods on a 40 nm Au colloid core. Batches were prepared with varying degrees of aggregation as described below to test both for SERS response and settling rate. The particles prepared for Example 4 have more heavily aggregated cores. TEM images of these aggregated particles are shown in FIG. 10. As shown in FIG. 11, these heavily aggregated particles exhibit a relatively higher SERS signal at both the 785 nm and 1064 nm excitation wavelengths, The heavily aggregated particles of Example 4 settle noticeably faster, however, than the unaggregated particles described above. The settling rate of particles manufactured with heavily aggregated 40 nm Au cores is significantly less than the settling rate for substantially unaggregated tags made with 90 nm Au cores. The UV-vis extinction data and all SERS spectra acquired in example 4 were acquired at a gold concentration of 12.5 μg/ml (w/v) which is 25% of the concentration of Examples 1-3

### Example 5

### SERS Tags from 40 nm Au—Lightly Aggregated

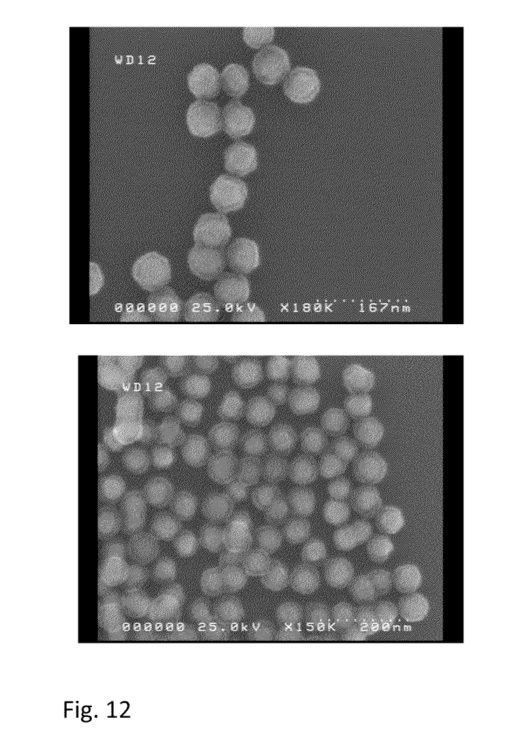

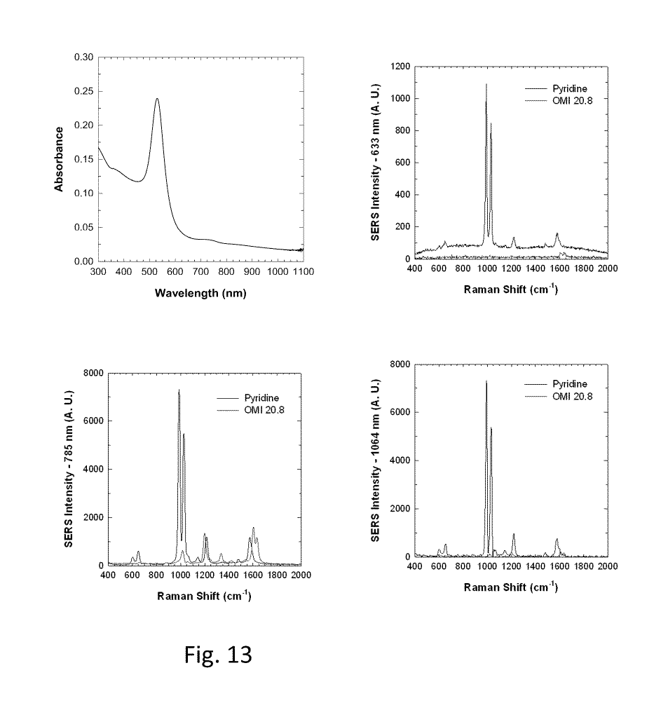

The particles prepared for Example 5 have less heavily aggregated cores. TEM images of these aggregated particles are shown in FIG. 12. As shown in FIG. 13, these lightly aggregated particles exhibit a substantial SERS signal at both the 785 nm and 1064 nm excitation wavelengths, The lightly aggregated particles of Example 4 settle somewhat faster, however, than the unaggregated particles described above. The settling rate of particles manufactured with lightly aggregated 40 nm Au cores is less than the settling rate for substantially unaggregated tags made with 90 nm Au cores. The UV-vis extinction data and all SERS spectra acquired in example 5 were acquired at a gold concentration of 12.5 μg/ml (w/v) which is 25% of the concentration of Examples 1-3

Unless otherwise indicated, all numbers expressing quantities of ingredients, dimensions reaction conditions and so forth used in the specification and claims are to be understood as being modified in all instances by the term “about”.

In this application and the claims, the use of the singular includes the plural unless specifically stated otherwise. In addition, use of “or” means “and/or” unless stated otherwise. Moreover, the use of the term “including”, as well as other forms, such as “includes” and “included”, is not limiting. Also, terms such as “element” or “component” encompass both elements and components comprising one unit and elements and components that comprise more than one unit unless specifically stated otherwise.

Various embodiments of the disclosure could also include permutations of the various elements recited in the claims as if each dependent claim was a multiple dependent claim incorporating the limitations of each of the preceding dependent claims as well as the independent claims. Such permutations are expressly within the scope of this disclosure.

While the various embodiments have been particularly shown and described with reference to a number of examples, it would be understood by those skilled in the art that changes in the form and details may be made to the various embodiments disclosed herein without departing from the spirit and scope of the invention and that the various embodiments disclosed herein are not intended to act as limitations on the scope of the claims. All references cited herein are incorporated in their entirety by reference.

The description of the embodiments has been presented for purposes of illustration and description, but is not intended to be exhaustive or limiting of the invention to the form disclosed. The scope of the present invention is limited only by the scope of the following claims. Many modifications and variations will be apparent to those of ordinary skill in the art. The embodiment described and shown in the figures was chosen and described in order to best explain the principles of the invention, the practical application, and to enable others of ordinary skill in the art to understand the invention for various embodiments with various modifications as are suited to the particular use contemplated.

What is claimed is:

1. A suspendable SERS nanotag comprising:
a metal core having a diameter of less than 90 nm;
a SERS active reporter molecule associated with the core; and
a silica containing encapsulant, encapsulating the core and reporter association.

2. The suspendable SERS nanotag of claim 1 wherein the metal core has a diameter of about 40 nm.

3. The suspendable SERS nanotag of claim 1 wherein the metal core has a diameter of about 25 nm.

4. The suspendable SERS nanotag of claim 1 wherein the metal core has a diameter of about 15 nm.

5. The suspendable SERS nanotag of claim 1 wherein the metal core is aggregated.

6. A method of manufacturing a suspendable SERS nanotag comprising:
providing a metal core having a diameter of less than 90 nm;
associating a SERS active reporter molecule with the metal core; and
encapsulating the core and reporter association with a silica containing encapsulant.

7. The method of manufacturing a suspendable SERS nanotag of claim 6 further comprising providing a metal core with a diameter of about 40 nm.

8. The method of manufacturing a suspendable SERS nanotag of claim 6 further comprising providing a metal core with a diameter of about 25 nm.

9. The method of manufacturing a suspendable SERS nanotag of claim 6 further comprising providing a metal core with a diameter of about 15 nm.

10. The method of manufacturing a suspendable SERS nanotag of claim 6 further comprising providing an aggregated metal core.
